(19) United States
(12) Patent Application Publication
(10) Pub. No.: US 2009/0133076 A1
(43) Pub. Date: May 21, 2009

(54) Portable Hand-held Media Device with Integrated Modulator

(75) Inventor: Mark Kolber, Churchville, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/942,946

(22) Filed: Nov. 20, 2007

(51) Int. Cl. H04N 7/18

(52) U.S. Cl. 725/74

(57) ABSTRACT

A portable hand-held media device includes a receiver configured to receive image data representing an image, a display unit configured to display the image, and an integrated modulator configured to convert the image data into a digital television (DTV) signal and transmit the DTV signal to a monitor.

### FIELD OF INVENTION

Disclosed herein are various embodiments relating to media devices and more specifically to portable hand-held media devices having integrated modulators.

### BACKGROUND

Hand-held media devices have become a ubiquitous part of today's society. Hand-held media devices include portable music players, cellular telephones (cell phones), portable DVD players, portable televisions (TVs), and similar devices. Many hand-held media devices have a display screen, which can play back still images and video. However, the display screens on most hand-held media devices are relatively small in size and, thus, cannot be viewed by multiple users.

Some hand-held media devices have the ability to connect to larger viewing monitors, such as TVs, but require specialized wires, routers, and other equipment. Purchasing and connecting this additional equipment adds additional cost and complexity. Moreover, the requirement for additional equipment reduces the portability of media devices, because the additional equipment must be carried along with the hand-held media device.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a wireless system, according to an embodiment;

FIG. 2 illustrates a portable hand-held media device, according to an embodiment;

FIG. 3 illustrates a portable telephone handset, according to an embodiment; and

FIG. 4 illustrates a flow chart of a method for wirelessly transmitting images to a monitor, according to an embodiment.

### DETAILED DESCRIPTION

For simplicity and illustrative purposes, the present invention is described by referring mainly to embodiments. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

According to an embodiment, a portable hand-held media device includes an integrated modulator to transmit image data to a monitor. Portable hand-held media devices are electronic devices, which can be carried by a user and have the capability of storing image data. Portable hand-held media devices are generally configured to operate using a battery as their primary power source. For example, portable hand-held media devices include cellular telephones (cell phones), voice over Internet protocol (VoIP) handsets, multi-mode handsets, portable digital video disc (DVD) players, portable televisions (TVs), digital music players, such as MP3 players, and the like. Many of these devices have display screens, which allow images, including still images and video, to be presented to a user. In one embodiment, the images may include video clips stored on the portable hand-held media devices in MPEG, MPEG-2, etc., format. However, the display screens of portable hand-held media devices are, by definition, relatively small in size to allow the media device to be light-weight, portable, and hand-held.

According to an embodiment, the portable hand-held media devices described herein include an integrated modulator, which facilitates the transmission of image data to a monitor by converting image data stored on the portable hand-held media device into a digital television (DTV) signal. DTV is a telecommunication system for broadcasting and receiving moving pictures and sound by means of digital signals, in contrast to analog signals used by analog (traditional) TV. DTV uses digital modulation data, which is digitally compressed and requires decoding by a monitor having a demodulator capable of demodulating the DTV signal.

A monitor receiving the DTV signal from the portable hand-held media device may be any device having a display screen for presenting images to a user. For example, the monitor may include TVs, computer screens, and the like or the monitor may be part of a system for receiving data, such as a personal computer. Generally, the monitor may have a display screen, which is larger than the display screen of the portable hand-held media device. As such, the portable hand-held media devices described herein my transmit image data stored on the portable hand-held media devices to a monitor having a larger viewing area. This allows the images stored on the portable hand-held media device to be viewed in a larger format and potentially by multiple users. However, a person having ordinary skill in the art will appreciate that the portable hand-held media devices described herein may transmit image data to monitors of any reasonably suitable size. For example, image data may be transmitted between portable hand-held media devices, such as cell phone to cell phone transmissions.

The modulator is integrated because the modulator is an integral or “built-in” component of the portable hand-held media device. In this manner, additional wires and equipment do not need to be connected to the portable hand-held media device in order to transmit image data from the portable hand-held media device to the monitor. The integrated modulator may be configured to convert the images stored on the portable hand-held media device into any reasonably suitable DTV format, such as 8-level vestigial sideband (8VSB) format. The 8VSB format is a standard radio frequency (RF) modulation format chosen by the Advanced Television Systems Committee (ATSC) for the transmission of digital television (DTV) signals in the United States and other adopting countries. In the US, the standard is specified by the Federal Communications Commission (FCC) for all digital television broadcasting. The 8VSB format is used in the transmission of video data, MPEG-2 for video signal compression, and Dolby Digital for audio coding.

The 8VSB format includes eight amplitude levels that support up to 19.28 Mbps of data in a single 6 MHz channel. There is also a 16VSB mode that has 16 amplitude levels and supports up to 38.57 Mbps of data on a 6 MHz channel. Because the 8VSB format is promulgated by the ATSC, many, if not all future televisions, computer monitors, etc. will be equipped with 8VSB receivers, which are capable of demodulating 8VSB signals and presenting images transmitted in the 8VSB format. The 8VSB format is currently only used by television stations to transmit digital television signals. Therefore, portable hand-held media device having integrated modulators capable of transmitting image data in 8VSB format will be compatible with a wide array of monitors.

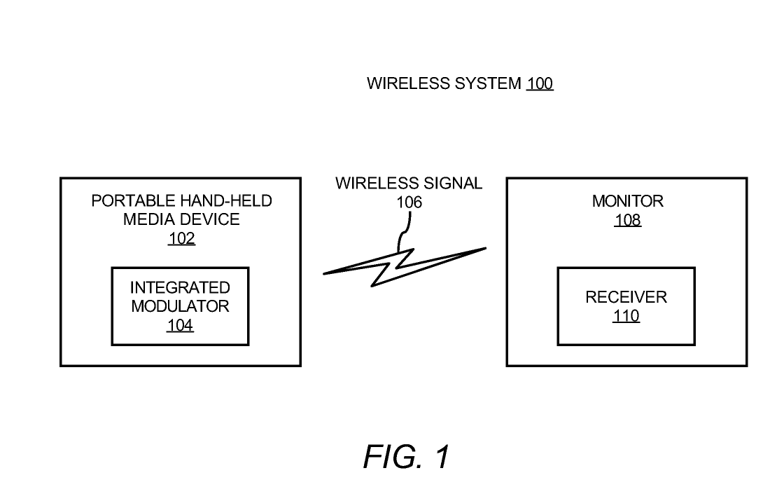

FIG. 1 illustrates a wireless system 100 for transmitting image data as a wireless signal 106 from a portable hand-held media device 102 to a monitor 108, according to an embodiment. It should be understood that the following description of the wireless system 100 is but one manner of a variety of different manners in which such a wireless system 100 may be configured. In addition, it should be understood that the wireless system 100 may include additional components and that some of the components described herein may be removed and/or modified without departing from a scope of the wireless system 100.

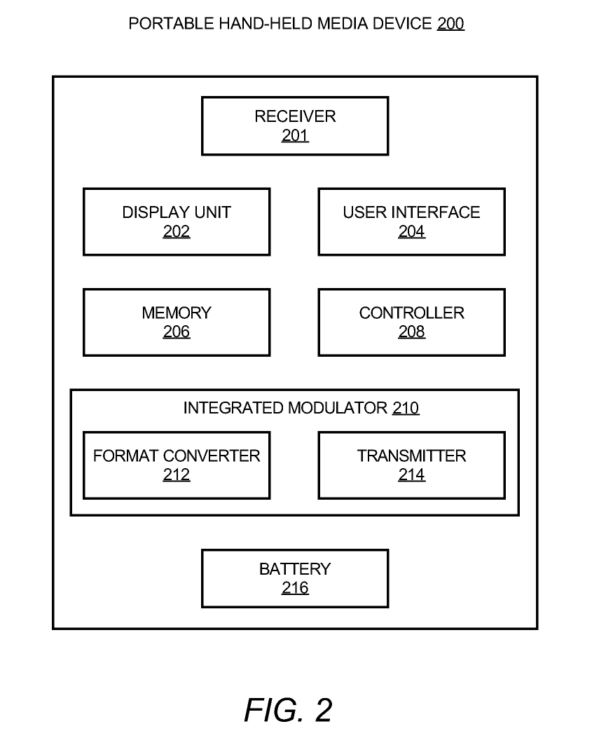

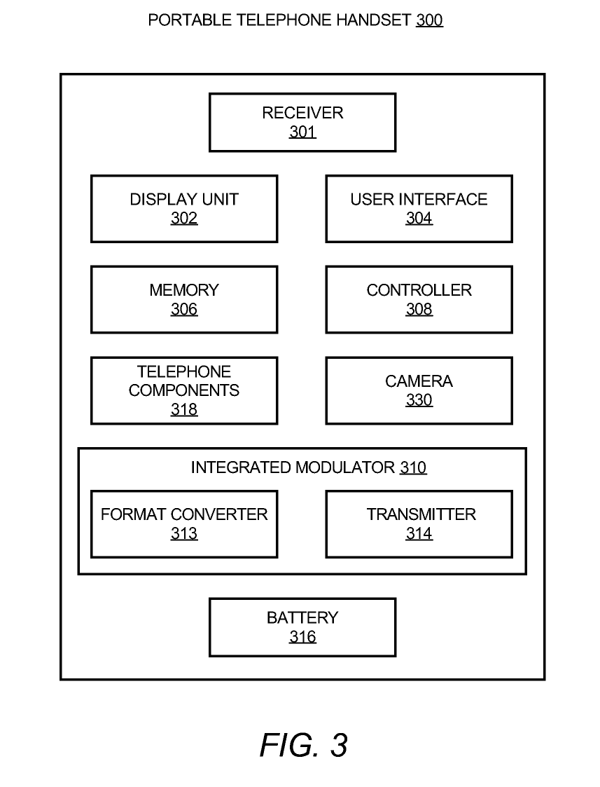

As set forth above, the portable hand-held media device 102 may include any reasonably suitable electronic device, which is capable of storing image data. For example, the portable hand-held media device 102 may include a cell phone or a portable DVD player. As such, the portable hand-held media device 102 may include many components not specifically illustrated in FIG. 1, as will be described in greater detail below with respect to FIGS. 2 and 3. The portable hand-held media device 102 includes an integrated modulator 104, which has the capability of converting image data, including still images and video, into the wireless signal 106 and transmitting the wireless signal 106. For example, the integrated modulator 104 may convert images stored on the portable hand-held media device 102 in any image or video format, such as JPEG, MPEG, MPEG2, etc., into an 8VSB RF signal and transmit the 8VSB RF signal to the monitor 108. The monitor 108 may include any device capable of receiving the wireless signal 106 and presenting images to a user. For example, the monitor 108 may include a TV or computer screen. The monitor 108 includes a receiver 110, which demodulates the wireless signal 106. In one example, the receiver 110 may be an 8VSB receiver for demodulating 8VSB signals.

In an embodiment, the monitor 108 may have a viewing area, which is larger than a display screen on the portable hand-held media device 102. For instance, the portable hand-held media device 102 may be a cell phone having a display screen for presenting images to a user. However, display screens on many cell phones are relatively small in size. As such, it is impractical for the user of the cell phone to share images with multiple individuals, such as family and friends. Therefore, the user of the portable hand-held media device 102 may wireless transmit image data from the portable hand-held media device 102 to a larger monitor, such as a TV. In this manner, the user can view the images in a larger format and more easily share the images with other individuals.

This functionality of the portable hand-held media device 102 is particularly useful because it does not require any additional wires or equipment. The user simply moves the portable hand-held media device 102 within range of the monitor 108 and transmits the wireless signal 106. The transmission range of the portable hand-held media device 102 may vary depending on the needs of the device. In one example, the portable hand-held media device 102 may have transmission ranges up to about 30, 50, and 70 feet. In addition, because the ATSC is promulgating the 8VSB format, most televisions will be equipped standard with 8VSB wireless receivers. Therefore, the integrated modulator 104 may be capable of transmitting the wireless signal 106 in 8VSB format to interact with most televisions. However, a person having ordinary skill in the art will appreciate that the integrated modulator 104 may be capable of transmitting the wireless signal 106 in any reasonably suitable format. For example, the 16VSB format or any other RF format may be used. Moreover, the wireless signal 106 may be in other forms such as infra-red (IR).

FIG. 2 illustrates a portable hand-held media device 200, which is capable of transmitting image data as a wireless signal 106, according to an embodiment. It should be understood that the following description of the portable hand-held media device 200 is but one manner of a variety of different manners in which such a portable hand-held media device 200 may be configured. In addition, it should be understood that the portable hand-held media device 200 may include additional components and that some of the components described herein may be removed and/or modified without departing from a scope of the portable hand-held media device 200.

As set forth above, the portable hand-held media device 200 may include any reasonably suitable electronic device, which is capable of storing image data. For example, the portable hand-held media device 200 may be a DVD player, and may be similar to the portable hand-held media device 102 described above, with respect to FIG. 1. The portable hand-held media device 200 includes a receiver 201, which allows the portable hand-held media device 200 to receive image data. For example, the receiver 201 may include a reading mechanism for reading a compact disc (CD) or DVD. Alternatively, or in addition thereto, the receiver 201 may include a wired or wireless interface for receiving image data from other electronic devices (not shown). For example, the receiver 201 may include a USB data port or the like. In other examples, the receiver 201 may include an integrated device for capturing image data, such as an embedded camera.

The portable hand-held media device 200 also includes a battery 216, which may be the primary power source for the portable hand-held media device 200. That is, while the portable hand-held media device 200 may be configured to drawn power from a dedicated alternating current (AC) power supply via a wired connection or plug, the battery 216 has the ability to act as the only power supply for the portable hand-held media device 200. The battery 216 may be any battery known in the art, such as Lithium-ion.

The portable hand-held media device 200 includes a display unit 202, a user interface 204, and a memory 206. The memory 206 may be any type of hardware or software, or combination thereof, for storing the image data received by the receiver 201. For example, the memory 206 may include random access memory (RAM), read only memory (ROM), flash memory, etc. The user interface 204 may include hardware, software, or a combination thereof which allows a user to interact with the portable hand-held media device 200. For example, the user interface 204 may include keyboards, number pads, touch screens, pointing devices, etc. A user may interact with the user interface 204 to receive the image data and initiate the transfer of image data to a monitor, as described in greater detail below. The display unit 202 may be any device for displaying image data to a user. For example, the display unit 202 may include a liquid crystal display (LCD) or plasma screen for presenting the image data received by the receiver 201.

The portable hand-held media device 200 includes a controller 208 and an integrated modulator 210. The controller 208 issues an enable signal to the integrated modulator 210 to initiate the transfer of image data from the portable hand-held media device 200 to a monitor. The controller 208 may include a processor and similar circuitry and may issue the enable signal in response to commands entered through a user's interaction with the user interface 204.

The integrated modulator 210 includes a format converter 212 and a transmitter 214. The format converter 212 converts the image data saved in the memory 206 into a format used for transmission. For example, the format converter 212 may convert MPEG files into an 8VSB format. The transmitter 214 transmits the converted image data to a monitor. Therefore, the transmitter 214 may include an RF transmitter, which streams the image data to the monitor.

FIG. 3 illustrates a portable telephone handset 300, which is capable of transmitting image data as a wireless signal 106, according to an embodiment. It should be understood that the following description of the portable telephone handset 300 is but one manner of a variety of different manners in which such a portable telephone handset 300 may be configured. In addition, it should be understood that the portable telephone handset 300 may include additional components and that some of the components described herein may be removed and/or modified without departing from a scope of the portable telephone handset 300.

The portable telephone handset 300 may include any device for transmitting voice data. For example, the portable telephone handset 300 may include a cell phone, a VoIP handset, a multi-mode handset, a cordless telephone handset for a plain old telephone service (POTS) network, etc. The portable telephone handset 300 includes a receiver 301, a display unit 302, a user interface 304, memory 306, a controller 308, and a battery 316, all of which may be substantially similar to the corresponding components described above with respect to FIG. 2.

However, the portable telephone handset 300 includes telephone components 318, which may include hardware and a combination of hardware and software for transmitting and receiving voice data. The telephone components 318 may include any known components for transmitting and receiving voice data. The portable telephone handset 300 is depicted as including a camera 330. The camera 330 may be any device known in the art for capturing image data. Although the receiver 301 and the camera 330 are depicted together in the portable telephone handset 300, the camera 330 may function in lieu of the receiver 301. That is, the camera 330 may act as the receiver 301 to capture image data and store the image data in the memory 306.

The portable telephone handset 300 includes an integrated modulator 310 having a format converter 313 and a transmitter 314. The integrated modulator 310 may be substantially similar to the integrated modulator 210, described above with respect to FIG. 2. As such, the integrated modulator 310 may convert the image data into a format, such as 8VSB, and transmit the converted image data as a wireless signal 106. In this manner, a user may view still images and/or video on the portable telephone handset 300 and also wirelessly transmit the image data to a monitor to view the still images and/or video on the monitor.

While FIGS. 1-3 depict wireless systems, it should be understood that a wired connection may be used in lieu of, or in addition to, a wireless signal to transmit an image from a portable hand-held media device to a monitor. That is, the portable hand-held media devices may have a DTV output interface, such as an 8VSB output, which allows a wire, cable, etc. to interface therewith. Similarly, the monitor may be equipped with a DTV interface, such as an 8VSB input, which is configured to receive a cable, wire, etc. capable of transmitting a DTV signal from the hand held media device to the monitor.

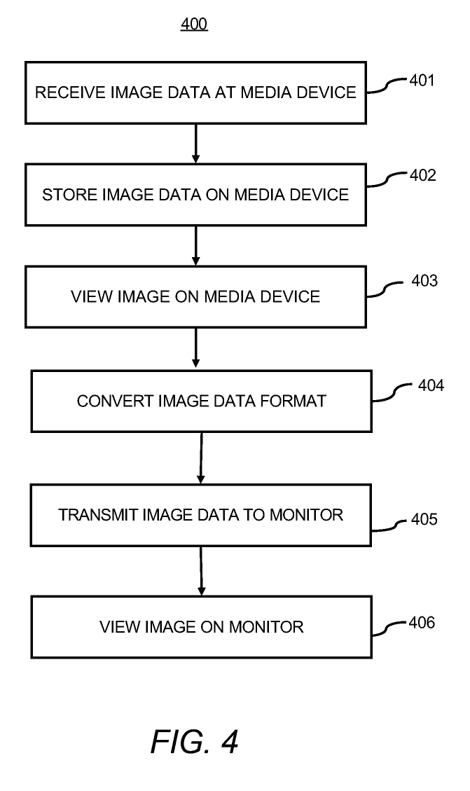

FIG. 4 depicts a flow chart of a method 400 for transmitting an image from a portable hand-held media device to a monitor, according to an embodiment. The method 400 is described with respect to FIGS. 2 and 3 by way of example and not limitation and it will be apparent that the method 400 may be used in other systems. Moreover, it will also be apparent to a person having ordinary skill in the art that certain steps in the method 400 are optional and, similarly, that additional steps may be inherent or added to the method 400.

At step 401, image data representing an image is received at a media device. The media device may be substantially similar to the portable hand-held media device 200, depicted in FIG. 2 or the portable telephone handset 300, depicted in FIG. 3. The image data may represent a still image or a series of still images. Alternatively, or in addition thereto, the image data may include video data representing video images. The video data may also include audio data associated therewith.

At step 402, the image data is stored locally on the media device. For example, the media device may include memory 206, 306 for storing the image data.

At step 403, the image is viewed on the media device. For example, the media device may include a display unit 202, 302, such as an LCD screen. A person having ordinary skill in the art will appreciate that this step is optional and may be eliminated or repeated without departing from the scope of the method 400.

At step 404, a determination is made that a monitor is within range and the format of the image data is converted. Conversion may be initiated based on commands entered by the user into a user interface 204, 304 the media device. The user's command may trigger a controller 208, 308 to send an enable signal to an integrated modulator 210, 310. The image data may be converted by the integrated modulator 210, 310 into any reasonably suitable format, such as 8VSB.

At step 405, the converted image data is transmitted to a monitor as a wired or wireless signal. For example, the integrated modulator 210, 310 may transmit the converted image data as an RF signal. The converted image data may be streamed to the monitor such that the image data is not stored at the monitor.

At step 406, the image data is viewed on the monitor. The monitor may include a TV, which is larger than the media device. Therefore, the images may be viewed in a larger format by a plurality of individuals.

One or more of the steps described herein are operable to be implemented as software or firmware stored on a computer readable medium. The steps are operable to be embodied by a computer program, which can exist in a variety of forms both active and inactive. For example, they exist as software and/or firmware program(s) comprised of program instructions in source code, object code, executable code or other formats for performing some of the steps. The codes described above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

Thus, the systems and methods described herein greatly improve the ability of a receiver to process a received signal. For example, a modem in the HFC network 100 may resolve impairments in downstream signals transmitted from the head-end 102 with increased proficiency and success. In this manner, receivers are provided with substantially greater reliability, because they are less prone to failure and loss of data. Moreover, the receivers described herein have the ability to produce a signal more accurately resembling the pure signal initially sent from a transmitter. [[advantages of invention: take out or put one related to this portable media player]]

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A portable hand-held media device comprising:
a receiver configured to receive image data representing an image;
a display unit configured to display the image; and
an integrated modulator configured to convert the image data into a digital television (DTV) signal and transmit the DTV signal to a monitor.

2. The portable hand-held media device of claim 1, further comprising:
a battery, wherein the battery is the primary power source for the portable hand-held media device.

3. The portable hand-held media device of claim 1, further comprising:
a memory configured to store the image data locally on the portable hand-held media device.

4. The portable hand-held media device of claim 1, wherein the image data includes video data which is streamed wirelessly to the monitor.

5. The portable hand-held media device of claim 1, wherein the receiver includes at least one of a wireless interface configured to wirelessly receive the image data and a camera configured to capture the image data.

6. The portable hand-held media device of claim 1, further comprising:
a controller configured to transmit an enable signal to the integrated modulator to initiate conversion of the image data into the DTV signal and transmission of the DTV signal.

7. The portable hand-held media device of claim 1, wherein the DTV signal is in 8VSB format and is transmitted wirelessly as a radio frequency (RF) signal.

8. The portable hand-held media device of claim 1, further comprising:
telephone components configured to receive and transmit voice data over a telephone network.

9. The portable hand-held media device of claim 1, wherein the portable hand-held media device is a voice over Internet protocol (VoIP) handset.

10. The portable hand-held media device of claim 1, wherein the portable hand-held media device is a cellular telephone.

11. A method comprising:
receiving image data representing an image at a portable hand-held media device;
modulating the image into a digital television (DTV) signal using a modulator integrated into the portable hand-held media device; and
transmitting the DTV signal from the portable hand-held media device to a monitor.

12. The method of claim 11, wherein receiving the image comprises recording the image using a camera embedded in the portable hand-held media device.

13. The method of claim 11, wherein receiving the image data comprises receiving video data and audio data and wherein transmitting the DTV signal comprises streaming the DTV signal wirelessly to the monitor.

14. The method of claim 11, wherein the portable hand-held media device includes a memory and the method further comprises:
storing the image data in the memory.

15. The method of claim 11, wherein transmitting the DTV signal comprises wirelessly transmitting an RF signal.

16. The method of claim 11, further comprising:
viewing the image on the monitor.

17. A computer readable medium on which is embedded one or more computer programs comprising a set of instructions that when executed by a processing circuit performs a method of transmitting an image comprising:
receiving image data representing the image at a portable hand-held media device;
modulating the image into a digital television (DTV) signal using a modulator integrated into the portable hand-held media device; and
transmitting the DTV signal from the portable hand-held media device to a monitor.

18. The computer readable medium of claim 17, wherein receiving image data further comprises:
capturing the image data using a camera embedded in the portable hand-held media device.

19. The computer readable medium of claim 17, wherein the computer readable medium is embodied in a portable hand-held media device, which operates primarily on battery power.

20. The computer readable medium of claim 17, wherein transmitting the DTV signal comprises transmitting the DTV signal in 8VSB format wirelessly as a radio frequency (RF) signal.
